(19) United States
(12) Patent Application Publication
(10) Pub. No.: US 2004/0039700 A1
(43) Pub. Date: Feb. 26, 2004

(54) Masking process for cards

(75) Inventor: Gene Richard Meier, Mound, MN (US)

Correspondence Address: MERCHANT & GOULD PC, P.O. BOX 2903, MINNEAPOLIS, MN, 55402-0903, US

(73) Assignee: DataCard Corporation, Minneapolis, MN

(21) Appl. No.: 10/242,093

(22) Filed: Sep. 11, 2002

Related U.S. Application Data
(60) Provisional application No. 60/405,625, filed on Aug. 23, 2002.

(51) Int. Cl. G06F 17/60

(52) U.S. Cl. 705/41

(57) ABSTRACT

A process for masking one or more predetermined portions of a surface of a card, for example a hologram, a signature area, or an area to be later personalized, to prevent a printed transfer media from being coated onto the predetermined surface portion as the transfer media is coated onto the remaining surface of the card. As a result of masking the predetermined surface portion, the predetermined surface portion is not covered by the transfer media.

### RELATED APPLICATION

This application claims the benefit of Provisional application Ser. No. ______ (Atty. Docket No. 2968.235USP1), filed on Aug. 23, 2002, entitled “Masking Process For Cards”.

### FIELD OF THE INVENTION

The invention relates to data bearing identification or financial cards, such as financial (e.g. credit and debit) cards, drivers' licenses, national identification cards, and other similar cards, as well as to other substrates. In particular, the invention relates to a masking process that results in improved cards and like substrates.

### BACKGROUND OF THE INVENTION

Identification and financial cards, such as financial (e.g. credit and debit) cards, drivers' licenses, national identification cards, and other like cards, are well known. These types of cards are often provided with data, graphics or a combination thereof composed of printed characters and/or images.

One way to provide data and graphics onto a card is to print the data and/or graphics directly onto the card using a printer. A second way to provide data and/or graphics onto a card is to print the data and/or graphics onto intermediate transfer media, with the transfer media then being coated, laminated or otherwise secured to a surface of the card. An example of a printer that utilizes an intermediate transfer media is the Artista™ printer produced by DataCard Corporation of Minnetonka, Minn.

In order to enhance the durability of the card and the printed material on the card, it is known to apply a protective layer on top of the transfer media. The protective layer provides enhanced resistance to abrasion and chemical attack. An example of a protective layer is disclosed in U.S. Pat. No. 6,245,382, which is hereby incorporated by reference in its entirety.

In the past, when the transfer media has been applied to a card, the transfer media has typically covered the entire surface of the card. However, there are areas on a card where one might not want the transfer media to cover, such as a hologram on the card, a signature area on a card, or other areas that are to be later personalized.

In the case of a card with a hologram, it has been found that when a protective layer is applied to the transfer media that covers a hologram, the application of the protective layer results in the removal of some of the transfer media over the area of the hologram with the removed transfer media preventing transfer of the protective layer over those areas, while portions of the transfer media over the hologram remains and is covered by the protective layer. The result is a hologram with an unattractive, inconsistent appearance, with a portion of the hologram covered by both the transfer media and the protective layer, and a portion of the hologram not being covered by either the transfer media or the protective layer.

### SUMMARY OF THE INVENTION

The invention relates to a process for masking one or more predetermined portions of a surface of a card, for example a hologram on the card, a signature area, and/or an area to be later personalized, to prevent a printed transfer media from being coated onto the predetermined surface portion as the transfer media is coated onto the remaining surface of the card. As a result of masking the predetermined surface portion, transfer media is not coated onto the surface portion.

In one embodiment, if a protective layer is thereafter applied over the card surface, the predetermined surface portion is covered only by the protective layer. The predetermined surface portion thus has a uniform coating of the protective layer thereover. When the predetermined surface portion is a hologram, the appearance of the hologram, including its brightness, is improved since the hologram is not covered by both the transfer media and the protective layer.

The invention has particular use in the production of cards, such as financial (e.g. credit and debit) cards, drivers' licenses, national identification cards, and other similar cards. The invention can also be used in the production of other coated documents in which it is desirable to prevent the application of a coating to a particular area of the document.

In one embodiment, the masking process is used to mask a hologram on the card to prevent transfer media from being coated over the hologram. The masking process could also be used to mask other areas of a card in which it may be desirable to prevent coating of the transfer media. For example, a signature area and/or an area of the card to be personalized at a later date can be masked.

A process for preventing the application of a coating to at least one predetermined portion of a surface of a card comprises masking the predetermined surface portion of the card, and applying the coating onto the surface of the card.

The masking on the predetermined portion of the card prevents adherence of the coating to the predetermined card surface portion, with the coating otherwise being applied to the unmasked portion(s) of the card.

In one embodiment, the coating comprises printed transfer media, and the masking material is applied to the transfer media prior to the transfer media being applied to the card. The masking material is preferably applied to the transfer media at a location that will correspond to the card surface portion to be protected when the transfer media is aligned with the card prior to application of the transfer media to the card. In this embodiment, the masking material remains with the carrier web for the transfer media after application of the transfer media to the card.

Alternatively, the masking material can be directly applied to the card surface portion to be protected prior to application of the transfer media. For example, in the case of a hologram, the masking material can be applied over the hologram by the hologram manufacturer so that when the hologram is affixed to the card surface, the masking material is already in place over the hologram. The masking material could either be left in place after the transfer media is applied if it is determined that the masking material does not detract from the appearance of the hologram. Otherwise, if the hologram appearance would be affected, the masking material could be removed from the card surface, such as by stripping the masking material from the card surface using the transfer media web as the transfer media is being applied to the remainder of the card surface.

The invention also relates to a thermal transfer ribbon that comprises a carrier web, and a coating on a surface of the carrier web, the coating comprising a masking material. The thermal transfer ribbon is used to apply the masking material onto the transfer media.

The masking material preferably comprises a high melting point resin, for example cellulose acetate, and a non-stick material, for example polytetrafluoroethylene. In addition, a layer of heat seal adhesive is added to the mask layer to aid in its transfer and adherence to the transfer media. The masking material can be applied to the transfer media using a thermal print head that includes a plurality of resistive elements, or using other suitable thermal elements.

For a better understanding of the invention, its advantages and objects obtained by its use, reference should be made to the drawings which form a further part hereof, and to the accompanying description, in which there is described a preferred embodiment of the invention.

### BRIEF DESCRIPTION OF THE DRAWINGS

FIG. 1 illustrates a card according to the present invention.

FIG. 2 is a cross-sectional view of the card taken along line 2-2 of FIG. 1.

FIG. 3 is a cross-sectional view of the card taken along line 3-3 of FIG. 1.

FIG. 4 illustrates the transfer media web containing a mask prior to being aligned with a card.

FIG. 5 is a partial cross-sectional view of the thermal transfer ribbon.

FIG. 6 is a partial cross-sectional view of the transfer media web after the mask is printed thereon.

FIG. 7 illustrates apparatus for printing the mask onto the transfer media and thereafter transferring the transfer media onto the card.

FIG. 8 illustrates a card according to an alternative embodiment.

FIG. 9 is a partial cross-section view of a web carrying a hologram with masking material pre-applied to the hologram.

### DETAILED DESCRIPTION OF THE INVENTION

The invention relates to a process for producing a personalized card, such as a credit card, that contains at least one predetermined area of the card that is not to be coated by a coating layer such as a printed transfer media. Data and graphics to be applied to the card are printed onto the intermediate transfer media of known construction using a printer. An example of printing onto an intermediate media for subsequent transfer of the printed material onto a card is known from U.S. Pat. No. 6,262,755, which is incorporated herein by reference in its entirety. An example of transferring a printed transfer media onto a card is disclosed in U.S. Pat. No. 6,263,796, which is hereby incorporated by reference. The use of an intermediate transfer media provides a number of advantages, including permitting edge to edge printing on a card and the application of printing to card surfaces that contain surface irregularities that would make direct printing onto the card difficult or impossible.

In addition, a mask material is applied to the transfer media at a location such that the mask material will be disposed over and cover the predetermined area of the card when the transfer media is positioned over the card ready to be applied to the surface of the card. The mask material is designed to adhere to the transfer media and prevent the mask material from adhering to the predetermined area of the card during application of the transfer media to the remainder of the card.

The mask material preferably comprises a combination of a high melting point resin, for example cellulose acetate, and non-stick particulates, for example polytetrafluoroethylene (PTFE) or wax. In addition, a layer of adhesive is added to the mask material to aid in transferring and adhering the mask material to the transfer media. The mask material is preferably provided in the form of a coating that is disposed on a carrier web. The mask material is transferred from the carrier web onto the transfer media using a thermal element, such as a thermal print head comprising a plurality of resistive elements. By heating selective ones of the resistive elements, the mask material that is transferred can be made to correspond in shape to the shape of the predetermined area of the card intended to be masked by the masking material.

After the mask material is applied to the transfer media, the transfer media, which has been preferably printed with data and/or graphics, is then positioned over the card, and heat and pressure are applied to transfer a portion of the transfer media, including the data and graphics printed thereon, to the card. The mask material, however, does not adhere to the predetermined card area and remains fixed to the transfer media. Further, the mask material prevents transfer of the transfer media in the location of the mask material onto the predetermined card area. As a result, the predetermined card area will not be covered by the transfer media or the mask material.

In certain embodiments, for example in high use cards, after the transfer media is applied, a protective coating can be applied over the card. The protective coating is applied over the entire card surface, including over the predetermined card area not coated by the transfer media. In this instance, portions of the card comprise a layer of both the transfer media and the protective layer, while the predetermined card area is covered only by the protective layer.

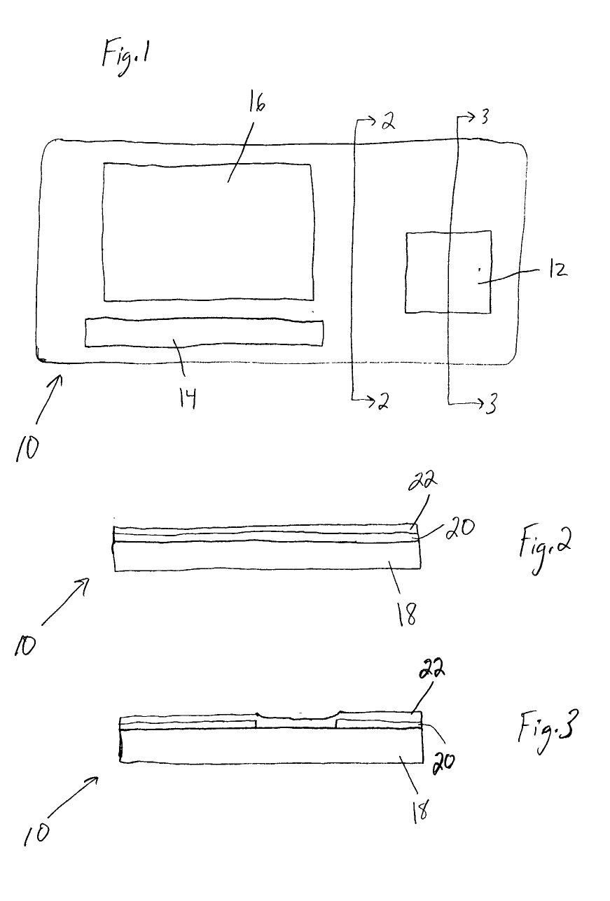

A card 10 according to the invention is shown in FIG. 1. The card 10, which is, for example, a credit card, contains a hologram 12 as well as a signature area 14 and an area 16 that is to be later personalized. For example, the area 16 can be personalized with a photo of the end user of the card, or with other data specific to the end user. Other information can also be provided on the card, such as card holder information including card holder name and account number, as well as information pertaining to the card provider.

As shown in FIG. 2, the card 10 comprises a plastic base 18, a layer 20 of intermediate transfer media disposed over the plastic base 18, and an optional protective layer 22 disposed over the transfer media layer 20.

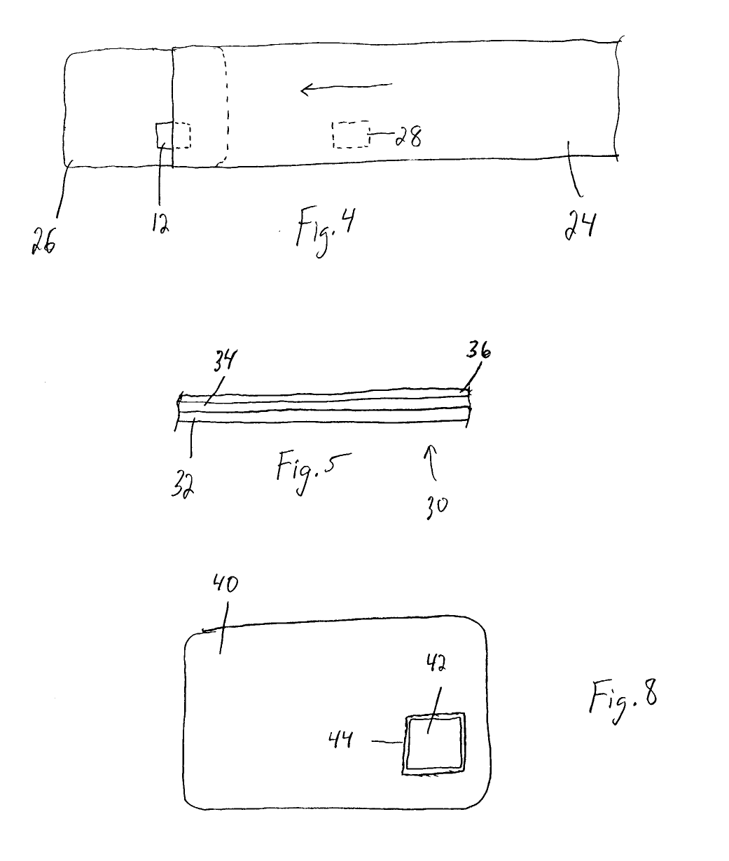

FIG. 3 illustrates a cross-sectional view of the card in the location of the hologram 12, showing a gap in the transfer media 20 at the location of the hologram 12. The hologram 12 is instead covered solely by the material of the protective layer 22 if the protective layer is provided. The gap in the transfer media 20 results from applying a mask according to the present invention over the hologram, which prevents transfer of the transfer media onto the hologram. The hologram 12 thus has a uniform coating of the protective layer thereover, and the appearance of the hologram, including its brightness, is improved since the hologram is not covered by both the transfer media and the protective layer.

A similar masking process could be used to prevent application of the transfer media 20 in the signature area 14, the area 16, or to any area(s) of the card in which it is determined that the transfer media might interfere with later personalization of that area.

FIG. 4 illustrates a transfer media web 24 that carries the transfer media 20 prior to application of the transfer media onto a card 26. A mask 28 is applied to the transfer media 20 on the web 24. The mask 28 corresponds in shape and size to the hologram 12 or other card area to be covered by the mask 28. Further, the mask 28 is applied to the transfer media 20 at a location such that when the web 24 is positioned relative to the card 26 ready to apply the transfer media onto the card surface, the mask 28 is positioned directly over and covers the hologram 12. As indicated above, the mask 28 prevents application of the transfer media onto the hologram 12, with the remaining surface of the card being coated by the transfer media. The mask 28 remains affixed to the web 24 as a new section of the web 24, containing new transfer media and a new mask 28, is brought into position for application of transfer media to a new card.

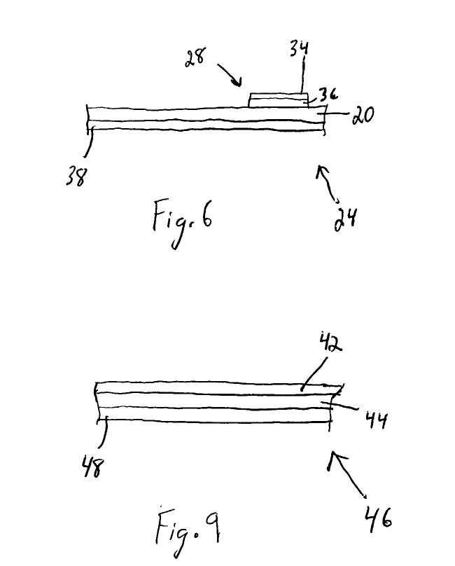

FIG. 5 illustrates a thermal transfer ribbon 30 according to the invention. The ribbon 30 preferably comprises a polyester carrier web 32 and a coating of masking material 34 on the web 32. In addition, an adhesive layer 36 is disposed over the mask layer 34. The adhesive layer 36 preferably comprises a vinyl or acrylic heat seal adhesive. The masking material 34 and adhesive 36 are designed to be transferred to the transfer media 20 using a thermal print head or the like in order to form the mask 28.

FIG. 6 illustrates the transfer media web 24 after the mask 28 is printed thereon. The web 24 comprises a polyester carrier 38 upon which the transfer media layer 20 is formed. The mask 28, including the masking material 34 and the adhesive layer 36, is disposed on the transfer media layer 20. The relative thicknesses of the various layers are exaggerated in order to illustrate the invention. In one embodiment, the transfer media is about 4 microns thick, while the mask 28 is about 0.1 microns thick.

Instead of applying the masking material to the transfer media, masking material could instead be applied directly onto the predetermined area of a card, for example over a hologram, a signature area, or an area to be later personalized. For example, in the case of a hologram, masking material could be applied directly to the hologram at the time of manufacture of the hologram such that when the hologram is attached to the card, the masking material is already in place.

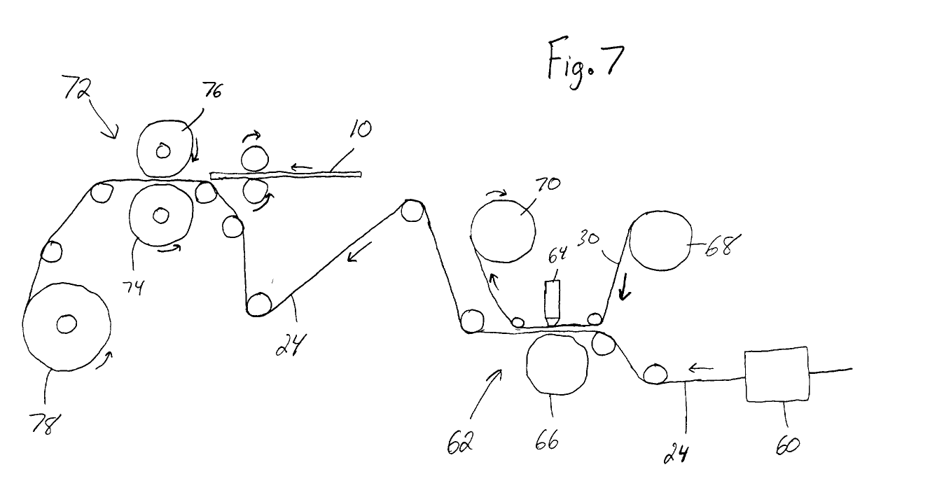

Referring to FIG. 7, the transfer media web 24 exits a printer mechanism 60 which prints the desired data and/or graphics onto the web 24. The web 24 then travels to a mask applicator station 62 where the mask 28 is applied to the web 24. The applicator station 62 comprises a thermal print head 64 and a platen roller 66 disposed opposite the print head 64 and forming a nip therebetween. The web 24 and the thermal transfer ribbon 30 travel through the nip to permit application of the mask 28 (i.e. the masking material 34 and the adhesive 36) onto the web 24 using the print head 64. The transfer ribbon 30 is supplied from a supply roll 68, and after application of the mask 28, is taken up on a take-up roll 70.

The web 24 with the mask 28 applied thereto then travels to a transfer station 72 where the portion of the web 24 with the printing and mask 28 thereon is aligned with the card 10 to which the transfer media 20 is to be applied. The transfer station 72 includes a pair of rollers 74, 76 forming a nip therebetween through which the card 10 and web 24 pass for transfer of the transfer media 20 onto the card. One of the rollers, preferably the roller 74, is heated which is necessary for the transfer process. The rollers 74, 76 also provide pressure to the card and web which is also necessary for proper transfer. Used web 24 is then taken up on a take-up roll 78. Further details on a transfer station and achieving alignment between the printed portion of the media and the card can be found in U.S. Pat. No. 6,263,796.

### EXAMPLE

Exemplary Transfer Ribbon 30 Formulation and Ribbon Formation Process:

| Transfer ribbon 30: | The web 32 comprises a backcoated, 5.7 micron | |
|---|---|---|
| | polyester carrier film. | |
| Mask layer 34: | Millbase: | 9.61 wt % cellulose acetate binder (e.g. |
| | | CA-398-30 available from Eastman |
| | | Chemical) |
| | | 2.88 wt % PTFE (e.g. Zonyl MP1100 |
| | | available from DuPont Corp.) |
| | | 87.51 wt % methyl ethyl ketone (MEK) |
| | | solvent |
| | Add all ingredients and mix until the cellulose | |
| | acetate is dissolved. Then the mixture is milled until | |
| | a Hegman grind greater than 8.0 is achieved. | |
| | Letdown: | 28.00 wt % above millbase |
| | | 2.63 wt % toluene |
| | | 69.37 wt % MEK |

| | |
|---|---|
| | Coat the letdown mixture on the non-backcoated |
| | side of the web 32 and let the solvents evaporate. |
| | The dry mask layer coat weight is preferably about |
| | 0.04 to about 0.4 grams per square meter, and most |
| | preferably from about 0.08 to about 0.12 grams per |
| | square meter. |
| | The ratio (by weight) of PTFE to binder is |
| | preferably about 5:100 to about 45:100, and most |
| | preferably about 30:100. |
| Adhesive layer 36: | 2.00 wt % acrylic resin (e.g. Elvacite 2008) |
| | 24.50 wt % MEK |
| | 73.50 wt % toluene |
| | Coat the adhesive mix on top of the mask layer 34 |
| | and let the solvents evaporate. The preferred dry |
| | adhesive layer coat weight is 0.03 to 0.10 grams per |
| | square meter, and more preferably from 0.05 to 0.10 |
| | grams per square meter. |
| | A vinyl resin, for example VMCH available from |
| | Union Carbide, could be used in place of acrylic |
| | resin. |

With respect to the mask layer, a binder such as cellulose acetate butyrate and cellulose acetate propionate could also be used. In addition, micronized wax dispersions or particles, for example high melting point polyolefins, could be used in place of PTFE.

Exemplary Mask Application:

The print head 64 voltage is preferably between about 21 volts to about 27 volts, and most preferably 25.5 volts. Print speed is about 1.05 in/sec, and print force is about 8.0 to 9.0 lbs.

Exemplary Transfer Media Transfer:

Application speed is about 3.8 to about 4.1 in/sec. Application force is about 90 to about 110 lbs. The heated roller 74 has a temperature of about 190° C. to about 220° C., and more preferably about 205° C.

FIG. 8 illustrates a card 40 with a hologram 42 that is pre-covered by a mask 44 of masking material. The mask 44 is shown for illustration purposes as being slightly larger in size than the hologram 42 to enable the mask 44 to be viewed. It is to be realized that the actual size of the mask 44 will be substantially equal to the size of the hologram 42 so that transfer media is applied to the entire card surface except for the hologram.

FIG. 9 is a partial cross-sectional view of a web 46 upon which the hologram 42 is disposed prior to application of the hologram 42 to the card 40. The web 46 comprises a carrier 48, for example a polyester carrier film, a layer of the masking material 44 provided on the carrier 48, and the hologram 42 disposed on the masking material layer 44. Upon application of the hologram 42 onto the card 40, the masking material 44 is in place over the hologram 42 to prevent coating of the transfer media onto the hologram.

The mask layer 44 can be coated onto the carrier 48 using the same technique described above with respect to applying the mask layer 34 to the carrier 32. The hologram 42 is then formed on the mask layer 44 using standard hologram formation techniques well known to those having ordinary skill in the art. The mask material underlying the hologram 42 acts as a release layer when the hologram is applied to the card surface in a manner well known to those having ordinary skill in the art.

In the event that the thickness of the mask 44 is such that it does not interfere with the quality of the hologram, the mask can be left in place on the hologram. On the other hand, in the event that the mask thickness does interfere with hologram quality, or if one simply wants to remove the mask 44, it can be removed from the hologram 42.

If the mask 44 is to be removed, the transfer media web could be used to effect removal. The material forming the mask 44 could be designed to bond to the transfer media web as a result of thermal effects during application of the transfer media to the card, so that the mask 44 becomes adhered to the transfer media web during application of the transfer media to the remainder of the card surface and the mask 44 is stripped from the hologram as the transfer media web is advanced. Any subsequent coating that is applied, such as the optional protective layer 22, would then adhere to the hologram 42.

The above specification, examples and date provide a complete description of the invention. Many embodiments of the invention, not explicitly described herein, can be made without departing from the spirit and scope of the invention.

What is claimed is:

1. A process for preventing the application of a coating to a predetermined portion of a surface of a card, comprising masking the predetermined surface portion of the card with a masking material, and applying the coating onto the surface of the card, whereby the masking material prevents application of the coating to the predetermined surface portion of the card.

2. The process of claim 1, wherein masking comprises applying the masking material to a coating media prior to the coating media being applied onto the surface of the card.

3. The process of claim 1, wherein masking comprises applying the masking material directly onto the predetermined surface portion of the card.

4. The process of claim 1, wherein the predetermined surface portion of the card comprises a hologram.

5. The process of claim 1, wherein the predetermined surface portion of the card comprises a signature area of the card.

6. The process of claim 1, wherein the predetermined surface portion of the card comprises an area of the card capable of being personalized.

7. A process for preventing the application of a coating to a hologram on a surface of a card, comprising:
masking at least a portion of the hologram with a masking material prior to applying the hologram to the surface of the card; and
applying the hologram to the surface of the card, with the masking material preventing application of a subsequently applied coating to the portion of the hologram covered thereby.

8. The process of claim 7, comprising masking the entire hologram with masking material, thereby preventing application of the subsequently applied coating to any portion of the hologram.

9. The process of claim 8, further comprising applying a coating to the surface of the card, the masking material preventing application of the coating to the hologram.

10. The process of claim 9, further comprising leaving the masking material in place on the hologram.

11. The process of claim 9, further comprising removing the masking material.

12. A thermal transfer ribbon, comprising:
a carrier web; and
a coating on a surface of the carrier web, the coating comprising a masking material.

13. The thermal transfer ribbon of claim 12, wherein the masking material comprises a high melting point resin and a non-stick material.

14. The thermal transfer ribbon of claim 13, wherein the resin comprises cellulose acetate, and the non-stick material comprises polytetrafluoroethylene.

15. The thermal transfer ribbon of claim 12, further including an adhesive layer on the masking material.

16. The thermal transfer ribbon of claim 15, wherein the adhesive layer comprises a heat seal adhesive.
